(19) United States
(12) Patent Application Publication
(10) Pub. No.: US 2016/0279894 A1
(43) Pub. Date: Sep. 29, 2016

(54) BREATHABLE AND ELASTIC SPACER FABRIC COMPOSITE AND METHOD FOR MAKING THE SAME

(71) Applicant: CHENG-TA TSAI, TAINAN (TW)

(72) Inventor: CHENG-TA TSAI, TAINAN (TW)

(21) Appl. No.: 14/794,936

(22) Filed: Jul. 9, 2015

(30) Foreign Application Priority Data
Mar. 26, 2015 (TW) 104204589

(51) Int. Cl. B32B 3/26; B32B 37/06; B32B 37/14; B32B 37/10; B32B 5/02; B32B 37/12

(52) U.S. Cl. CPC B32B 3/266; B32B 5/026; B32B 37/1207; B32B 37/14; B32B 37/10; B32B 37/06; B32B 2307/51; B32B 2307/724; B32B 2037/1215

(57) ABSTRACT

A breathable and elastic spacer fabric composite includes a layered fabric and an elastic layer bonded to the layered fabric. The layered fabric is a so-called spacer fabric. The elastic layer has a plurality of substantially uniformly distributed through holes. The elasticity and through holes of the elastic layer render the entire fabric composite elastic while maintaining the breathability of the layered fabric such that the fabric composite is applicable not only to common clothes, but also to products requiring high fabric elasticity, e.g., sporting and medical braces. A method for making the breathable and elastic spacer fabric composite is also provided. The method prevents the adhesive used to bond the elastic layer to the layered fabric from seeping into and clogging the tiny pores of the layered fabric and ensures a high bonding strength between the elastic layer and the layered fabric.

### BACKGROUND OF THE INVENTION

1. Technical Field

The present invention relates to a spacer fabric composite and its manufacturing method. More particularly, the present invention relates to a highly breathable and highly elastic spacer fabric composite and a method for making the same.

2. Description of Related Art

A so-called spacer fabric is a knitted fabric with a three-layer structure consisting of an upper knitted-fabric layer, a lower knitted-fabric layer, and an intermediate spacer yarns layer connecting the two knitted-fabric layers. Each of the three layers is made by knitting, or more specifically by interweaving warp and weft yarns. As the layered structure and its numerous surface pores allow easy passage of air, a spacer fabric is more breathable and tends to feel drier and more comfortable than other common planar surface materials. This explains why spacer fabrics have found wide application in bags, shoes, mattresses, and many other fields.

However, spacer fabrics in general do not have high elasticity. They can be stretched to a certain extent but may not resume their original shapes immediately when released. Hence, despite their extensive use, spacer fabrics have yet to be applied to products demanding high fabric elasticity, such as elbow supports, knee supports, and like sporting and medical braces.

The market nowadays is supplied with elastically stretchable spacer fabrics featuring adequate elasticity. These fabrics are made by incorporating an elastic fiber (e.g., Opelon (OP), Lycra, Spandex, or Elastane) or rubber thread into the knitting process so that the resultant spacer fabrics are enhanced in elasticity. These elastically stretchable spacer fabrics are used mainly in the female underwear industry, and the reason why they can be so used is that the fabrics of female underwear do not require very high elasticity. In other words, such elastically stretchable spacer fabrics are still not elastic enough to be used in products requiring higher fabric elasticity, such as knee supports, elbow supports, and like sporting and medical braces.

To expand the range of applications of spacer fabrics, therefore, it is imperative to increase their elasticity.

Conventionally, there are methods by which two or more fabrics can be joined together to form a fabric composite still retaining the properties of each constituent fabric. None of these conventional methods, however, are suitable for joining a spacer fabric to a highly elastic fabric or an elastomer, as explained in more detail below. The conventional joining methods typically involve applying an adhesive to a fabric and then bonding the fabric to another fabric. Since the adhesive is generally in a liquid state, it tends to seep into the tiny pores of a spacer fabric when directly applied thereto. As a result, only a small amount of adhesive remains on the surface, and the bond between the spacer fabric and the other fabric (or an elastomer) is compromised. Moreover, the adhesive seeping into the intermediate and/or lower layer of the spacer fabric will harden and stay in the fabric when solidified, thus not only stiffening the spacer fabric, but also depriving it of its flexibility and pliability. Consequently, the goal of increasing t he elasticity of the spacer fabric by joining it with another fabric or an elastomer becomes unattainable.

A conventional alternative is to spray the adhesive only on certain spots on the fabrics to be bonded, with a view to reducing the adhesive used and preventing the adhesive from clogging the fabrics. But this method is not suitable for use with spacer fabrics. If an adhesive is sprayed only on certain spots on a spacer fabric, the adhesive remaining on the fabric surface will be even less than if the adhesive is applied to the entire surface of the fabric. The bond between the spacer fabric and the other fabric (or an elastomer) will also be weaker. After repeated stretching, therefore, the spacer fabric and the fabric (or elastomer) bonded thereto may separate from each other. Such a fabric composite can never be used in sporting and medical braces requiring high elasticity.

While U.S. Pat. No. 7,426,840 B2, entitled “Spacer fabric with integral, exposed loops and method of making”, discloses a spacer fabric with integral, exposed fiber loops functioning as the loops of a hook-and-loop fastener (generally known as Velcro), the fabric is made by knitting and hence departs from what the present invention intends to improve.

### BRIEF SUMMARY OF THE INVENTION

To further increase the elasticity of spacer fabrics and thereby expand the application of such fabrics to sporting and medical braces demanding high elasticity, such as elbow supports and knee supports, the applicant conducted extensive research and experiment and finally succeeded in developing a breathable and elastic spacer fabric composite and a method for making the same as disclosed herein. The spacer fabric composite is rendered elastic by bonding an elastic layer to a layered fabric (a so-called spacer fabric), and a strong bond between the layered fabric and the elastic layer is ensured.

According to one aspect of the present invention, a breathable and elastic spacer fabric composite which includes a layered fabric and an elastic layer is provided. The layered fabric includes two knitted-fabric layers and a spacer yarns layer. The spacer yarns layer is located between and connects the two knitted-fabric layers. The elastic layer is bonded to the layered fabric, has a thickness ranging from 0.01 mm to 1.5 mm, and is provided with a plurality of through holes. Each through hole has a cross-sectional area ranging from 0.01 mm² to 50 mm².

Preferably, the through holes of the elastic layer are substantially uniformly distributed over the entire area or a partial area of the elastic layer.

Preferably, the elastic layer is in the form of a mesh.

Preferably, the layered fabric is provided with a plurality of through holes each having a cross-sectional area ranging from 0.01 mm² to 50 mm².

Preferably, the through holes of the layered fabric are substantially uniformly distributed over the entire area or a partial area of the layered fabric.

Preferably, the elastic layer is added with one or a combination of a far-infrared material, a negative-ion material, an anti-bacterial material, a tourmaline material, a bamboo charcoal powder material, a cool sensation-producing material, a heat-generating material, a titanium material, and a geranium material.

Preferably, the elastic layer is one or a combination of a thermoplastic elastomer film, a thermoplastic polyurethane film, a polyurethane film, an ethylene-vinyl acetate copolymer film, a thermoplastic polyolefin film, a thermoplastic polyamide elastomer film, and a hot-melt adhesive film.

Preferably, the elastic layer is made of one of a natural rubber, a silicone rubber, a thermoplastic rubber, a styrene-butadiene rubber (SBR), a chloroprene rubber, and a synthetic rubber.

Preferably, the breathable and elastic spacer fabric composite further includes an elastic fabric bonded to the elastic layer. The elastic fabric is one of a knitted elastic fabric, an elastic hook-and-loop fastening fabric, a velcro plush, a far-infrared elastic fabric, a negative-ion elastic fabric, an anti-bacterial elastic fabric, a tourmaline elastic fabric, a bamboo charcoal-based elastic fabric, a geranium elastic fabric, a moisture-absorbing and perspiration-dissipating elastic fabric, a cool sensation-producing elastic fabric, a heat-generating elastic fabric, a titanium elastic fabric, a synthetic-fiber elastic fabric, and a natural-fiber elastic fabric.

Preferably, the elastic fabric is provided with a plurality of through holes distributed substantially uniformly over the entire area or a partial area of the elastic fabric.

According to another aspect of the present invention, a method for making a breathable and elastic spacer fabric composite is provided, wherein the method includes the steps of:

bonding an elastic layer to a layered fabric, wherein the layered fabric includes two knitted-fabric layers and a spacer yarns layer, the spacer yarns layer is located between and connects the two knitted-fabric layers, and the elastic layer has a thickness ranging from 0.01 mm to 1.5 mm; and performing a perforation process to provide at least the elastic layer with a plurality of through holes, wherein each through hole has a cross-sectional area ranging from 0.01 mm² to 50 mm².

Preferably, the through holes are substantially uniformly distributed over the entire area or a partial area of the elastic layer.

Preferably, the perforation process is performed with a mechanical perforator or a laser beam.

Preferably, the elastic layer includes a first hot-melt adhesive film and a second hot-melt adhesive film bonded with each other. The first hot-melt adhesive film has a first melting point, and the second hot-melt adhesive film has a second melting point. The first melting point is lower than the second melting point. The layered fabric is bonded to the first hot-melt adhesive film by hot-press lamination, with a hot-press lamination temperature higher than the first melting point and lower than the second melting point.

Preferably, the elastic layer is sprayed with an adhesive and then bonded to the layered fabric.

Preferably, when the elastic layer is one or a combination of a thermoplastic elastomer film, a thermoplastic polyurethane film, a polyurethane film, an ethylene-vinyl acetate copolymer film, a thermoplastic polyolefin film, a thermoplastic polyamide elastomer film, and a hot-melt adhesive film, the elastic layer is bonded to the layered fabric while in a molten state and in the form of a mesh during the manufacturing process of the elastic layer and, once solidified, forms a meshed elastic layer bonded with the layered fabric and defining the through holes.

Preferably, the method further includes the step of incorporating an elastic fabric.

Preferably, when the elastic layer is one or a combination of a thermoplastic elastomer film, a thermoplastic polyurethane film, a polyurethane film, an ethylene-vinyl acetate copolymer film, a thermoplastic polyolefin film, a thermoplastic polyamide elastomer film, and a hot-melt adhesive film, the elastic fabric is bonded to one side of the elastic layer by hot-press lamination before the layered fabric is bonded to the other side of the elastic layer by hot-press lamination.

Preferably, when the elastic layer is one or a combination of a thermoplastic elastomer film, a thermoplastic polyurethane film, a polyurethane film, an ethylene-vinyl acetate copolymer film, a thermoplastic polyolefin film, a thermoplastic polyamide elastomer film, and a hot-melt adhesive film, the elastic layer is bonded between the layered fabric and the elastic fabric while in a molten state and in the form of a mesh during the manufacturing process of the elastic layer and, once solidified, forms a meshed elastic layer bonded with the layered fabric and the elastic fabric and defining the through holes.

Preferably, when the elastic layer is made of one of a natural rubber, a silicone rubber, a thermoplastic rubber, a styrene-butadiene rubber, a chloroprene rubber, and a synthetic rubber by a hot extrusion process, the elastic layer is bonded to the layered fabric and the elastic fabric during the hot extrusion process while the elastic layer is not yet completely solidified and is viscous; and the perforation process is performed on the layered fabric, the elastic layer, and the elastic fabric after the elastic layer solidifies completely.

The present invention has the following effects:

1. The spacer fabric composite of the present invention includes a layered fabric and an elastic layer bonded to the layered fabric in order for the resulting fabric composite to have high elasticity. As the elastic layer has a plurality of through holes to facilitate air circulation, and the layered fabric itself is highly breathable already, the spacer fabric composite of the present invention features excellent breathability.

2. The breathable and elastic spacer fabric composite of the present invention may further include an elastic fabric bonded to the elastic layer. In addition to serving esthetic purposes, the elastic fabric imparts its own properties (e.g., a far infrared-related, negative ion-related, or anti-bacterial function) to the fabric composite or may serve as a hook-and-loop fastener so that the present invention is applicable to sporting and medical braces.

3. The elastic layer of the present invention can be cut into a particular shape and then bonded to the layered fabric, which retains its integrity, so that the resulting spacer fabric composite is elastic only in a particular area and can serve as a 3D brace for providing localized protection.

4. The method of the present invention for making a breathable and elastic spacer fabric composite includes the step of performing a perforation process to provide at least the elastic layer with a plurality of through holes. The through holes reduce the chance of the layered fabric being clogged by a seeping adhesive and also make the resulting spacer fabric composite more elastic than those bonded in a conventional way.

5. The method of the present invention for making a breathable and elastic spacer fabric composite allows the layered fabric and the elastic layer to be bonded without using adhesive, either by hot-press lamination or by bonding the elastic layer to the layered fabric during the manufacturing process of the former and while the former is not yet completely solidified. Whether the perforation process is performed before or after the bonding step, the resulting spacer fabric composite will be breathable and elastic.

6. The method of the present invention for bonding the elastic layer to the layered fabric ensures a high bonding strength between the elastic layer and the layered fabric. Thus, when the resulting fabric composite is applied to a sporting and medical brace demanding extremely high elasticity or a hook-and-loop fastener that needs to be peeled open and closed repeatedly, separation between the elastic layer and the layered fabric will not occur after repeated use, nor will the hook-and-loop fastener be detached from the spacer fabric composite.

7. The method of the present invention enables spacer fabric composite to be used in the sporting and medical brace industry and further enhances the breathability of braces.

### BRIEF DESCRIPTION OF THE SEVERAL VIEWS OF THE DRAWINGS

FIG. 1 is a perspective view of the breathable and elastic spacer fabric composite in an embodiment of the present invention;

FIG. 2 is a perspective view showing the layered fabric in FIG. 1 also having a plurality of through holes for enhanced breathability;

FIG. 3 is a perspective view showing the breathable and elastic spacer fabric composite in FIG. 1 further bonded with an elastic fabric;

FIG. 4 is a schematic drawing in which the elastic fabric in FIG. 3 serves as a hook-and-loop fastener of a knee support;

FIG. 5 schematically shows how the knee support in FIG. 4 is used, wherein the knee support has a hook-and-loop fastener formed by the elastic fabric in FIG. 3;

FIG. 6 is a schematic drawing in which the elastic layer in the embodiment of FIG. 1 is pre-cut into a specific shape before it is bonded to the layered fabric;

FIG. 7 is a schematic drawing in which the elastic layer in the embodiment of FIG. 1 is pre-cut into a specific shape and then bonded to the layered fabric to form a 3D knee support with a specific stretchable area; and

FIG. 8 schematically shows how the 3D knee support in FIG. 7 is used.

### DETAILED DESCRIPTION OF THE INVENTION

The present invention incorporates the technical features described above into a breathable and elastic spacer fabric composite and a method for making the same. The major effects of the fabric composite and the method are apparent from the following embodiments.

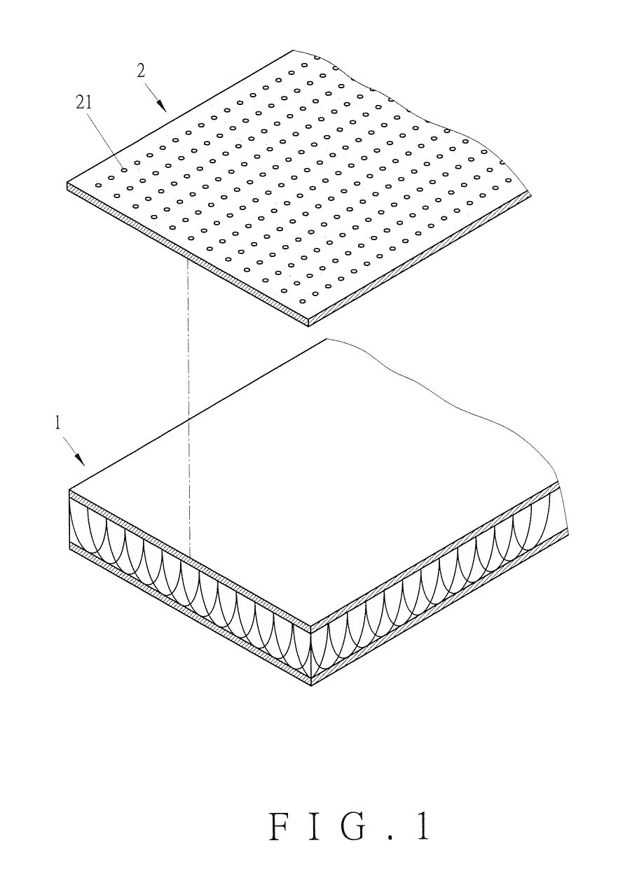

Referring to FIG. 1, the breathable and elastic spacer fabric composite in an embodiment of the present invention includes a layered fabric 1 and an elastic layer 2.

The layered fabric 1 includes two knitted-fabric layers and a spacer yarns layer. The spacer yarns layer lies between and connects the two knitted-fabric layers. The elastic layer 2 is bonded to the layered fabric 1 and has a thickness ranging from 0.01 mm to 1.5 mm. The elastic layer 2 is provided with a plurality of through holes 21. Each through hole 21 has a cross-sectional area ranging from 0.01 mm² to 50 mm².

The layered fabric 1, a so-called spacer fabric, has high breathability attributable to its layered structure and is rendered elastic by the elasticity of the elastic layer 2 bonded to the layered fabric 1. The through holes 21 in the elastic layer 2 also allow passage of air. Therefore, the spacer fabric composite in this embodiment features both high breathability and elasticity.

In order to provide the desired elasticity, the elastic layer 2 may be one or a combination of a thermoplastic elastomer film, a thermoplastic polyurethane film, a polyurethane film, an ethylene-vinyl acetate copolymer film, a thermoplastic polyolefin film, a thermoplastic polyamide elastomer film, and a hot-melt adhesive film; or be one of a natural rubber, a silicone rubber, a thermoplastic rubber, a styrene-butadiene rubber, a chloroprene rubber, and a synthetic rubber.

There are no limitations on the shape of the through holes 21. The through holes 21 may be circular, rectangular, or of any other shapes. The elastic layer 2 itself, therefore, may be formed as a mesh in order to define the through holes 21. Preferably, but without limitation, the through holes 21 are distributed over the entire area of the elastic layer 2 in a substantially uniform manner. The through holes 21 may also be substantially uniformly distributed over only a partial area of the elastic layer 2 in order to impart breathability to that partial area. The range over which the through holes 21 are distributed depends on the desired extent of the breathable area.

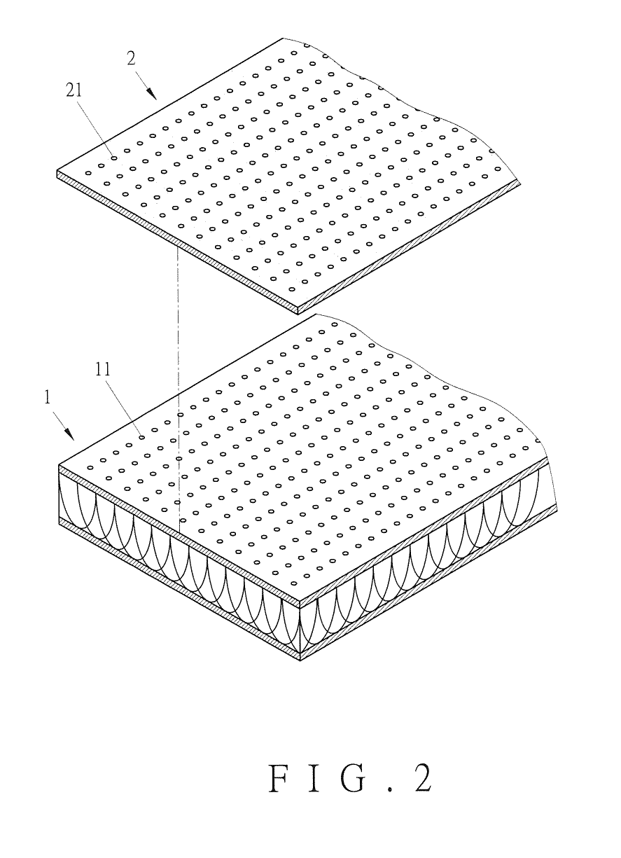

In another preferred implementation of this embodiment as shown in FIG. 2, the layered fabric 1 of the breathable and elastic spacer fabric composite is also provided with a plurality of through holes 11, each having a cross-sectional area ranging from 0.01 mm² to 50 mm². The through holes 11 are substantially uniformly distributed over the entire area or only a partial area of the layered fabric 1 in order for the entire spacer fabric composite in this embodiment or only a portion thereof to have enhanced breathability.

In addition, the elastic layer 2 may be added with one or a combination of a far-infrared material, a negative-ion material, an anti-bacterial material, a tourmaline material, a bamboo charcoal powder material, a cool sensation-producing material, a heat-generating material, a titanium material, and a geranium material, in order for the spacer fabric composite in this embodiment to have the far infrared-related, negative ion-related, and/or other functions of the aforesaid material(s).

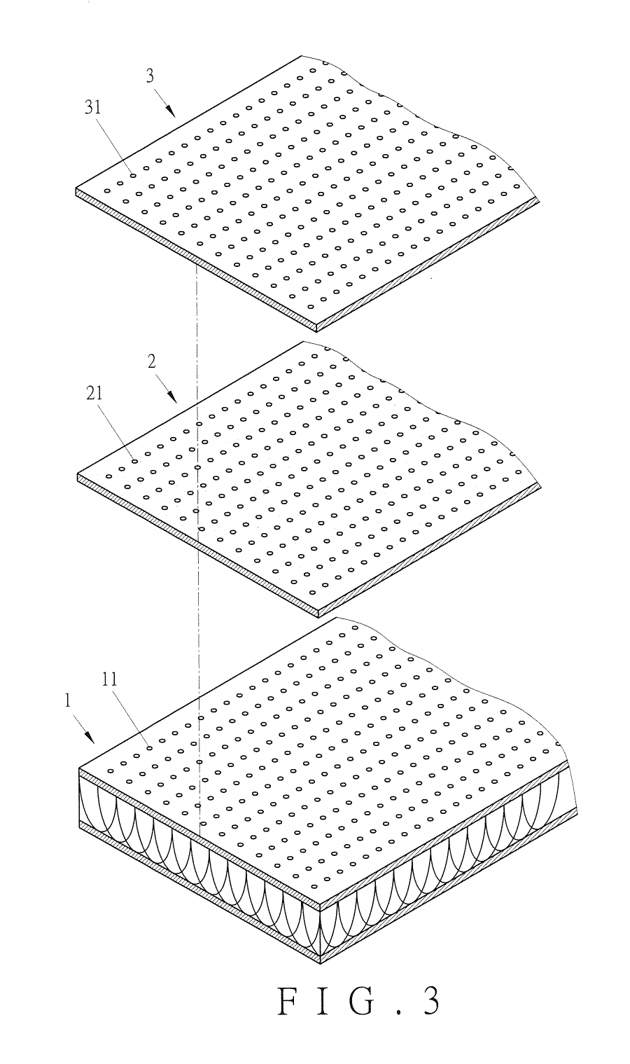

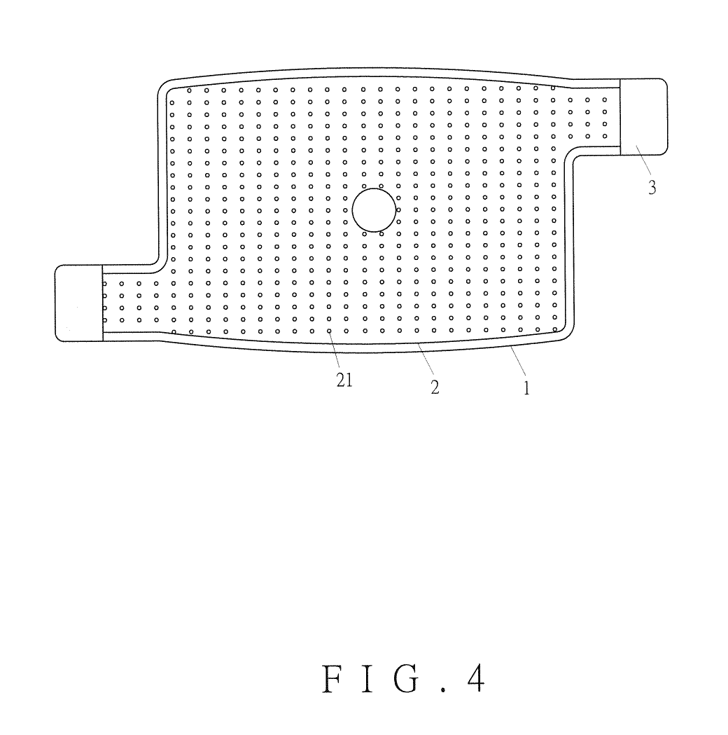

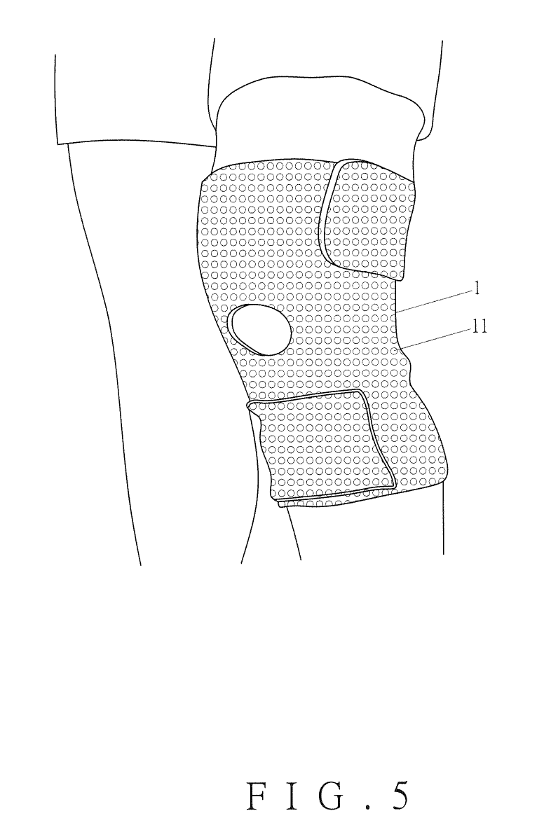

In yet another preferred implementation of this embodiment as shown in FIG. 3, FIG. 4, and FIG. 5, the breathable and elastic spacer fabric composite further includes an elastic fabric 3 bonded to the elastic layer 2, and the elastic fabric 3 may also be provided with a plurality of through holes 31 for enhanced breathability. The elastic fabric 3 may be, for example, one of a knitted elastic fabric, an elastic hook-and-loop fastening fabric, a velcro plush, a far-infrared elastic fabric, a negative-ion elastic fabric, an anti-bacterial elastic fabric, a tourmaline elastic fabric, a bamboo charcoal-based elastic fabric, a geranium elastic fabric, a moisture-absorbing and perspiration-dissipating elastic fabric, a cool sensation-producing elastic fabric, a heat-generating elastic fabric, a titanium elastic fabric, a synthetic-fiber elastic fabric, and a natural-fiber elastic fabric. The elastic fabric 3 not only serves as the outer layer of and to esthetically enhance the spacer fabric composite in this embodiment, but also imparts its own distinctive effects to the spacer fabric composite. For instance, referring t o FIG. 4, the elastic fabric 3 is an elastic hook-and-loop fastening fabric so that the spacer fabric composite can be used as a sporting and medical brace with hook-and-loop fasteners, such as an elbow support or a knee support.

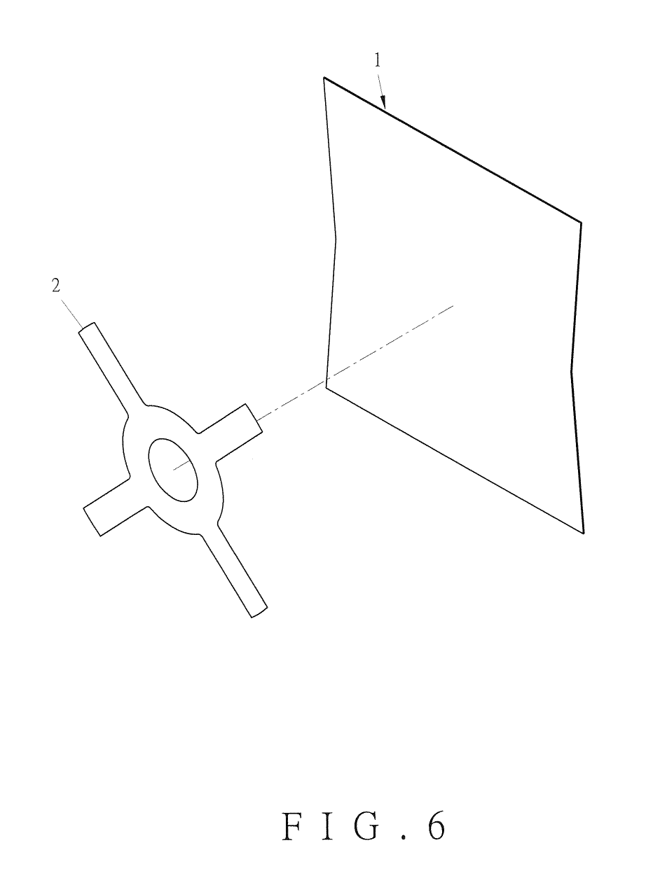

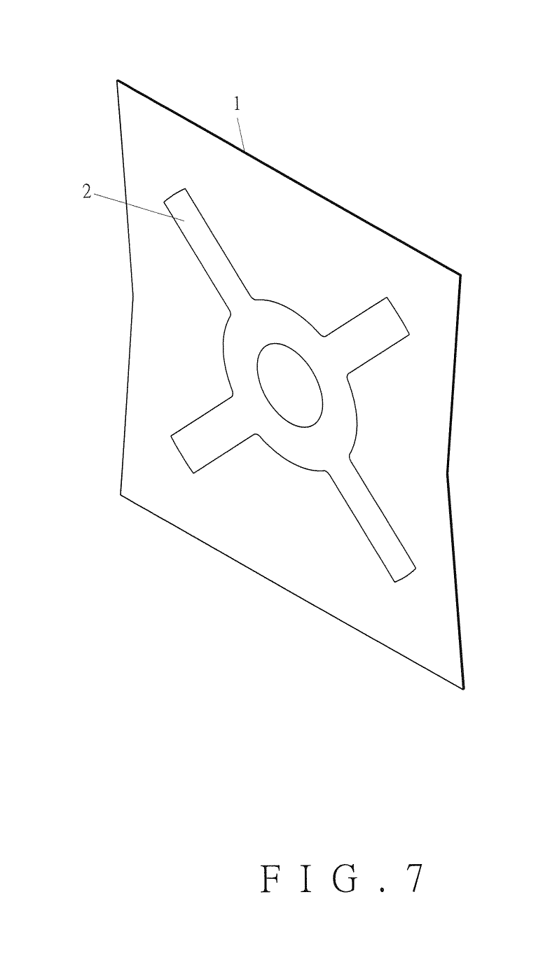

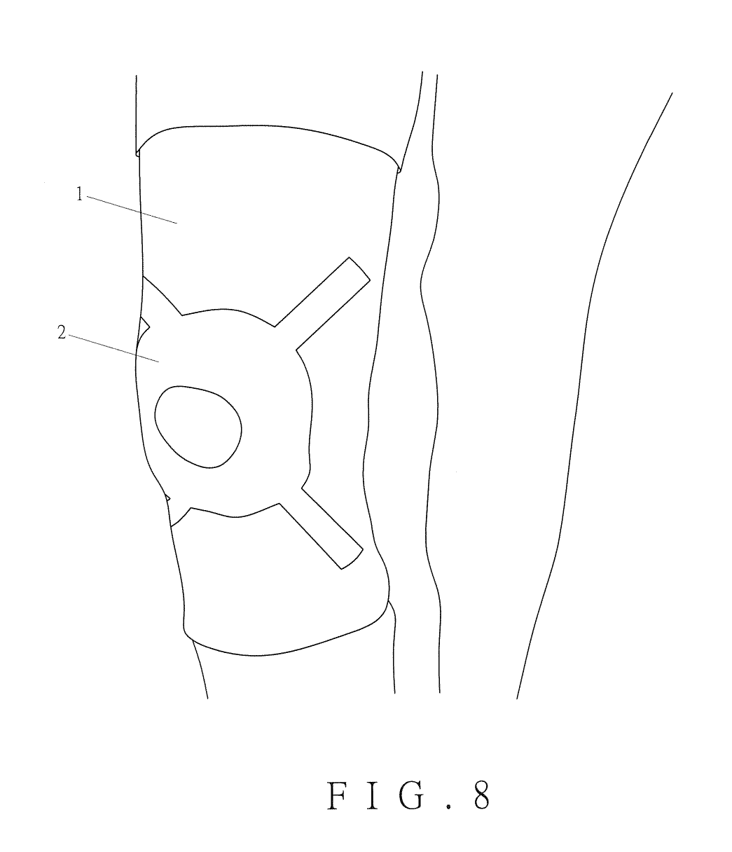

FIG. 6, FIG. 7, and FIG. 8 show another way of using the breathable and elastic spacer fabric composite in this embodiment. As shown in the drawings, the elastic layer 2 is cut into a particular shape in advance and then bonded to the layered fabric 1, which retains its integrity. The precut and particularly shaped elastic layer 2 imparts elasticity to a certain area of the spacer fabric composite in order to provide localized protection for its user. In FIG. 8, for example, the spacer fabric composite is made into a 3D knee support for providing localized protection to the user's knee, and precutting the elastic layer 2 helps reduce the material of the elastic layer 2 required for the 3D knee support.

The method for making the breathable and elastic spacer fabric composite in this embodiment is carried out as follows.

An elastic layer is bonded to a layered fabric, wherein the layered fabric includes two knitted-fabric layers and a spacer yarns layer located between and connecting the two knitted-fabric layers, and wherein the elastic layer has a thickness ranging from 0.01 mm to 1.5 mm. Also, a perforation process is performed such that a plurality of through holes are formed at least in the elastic layer. The through holes, each having a cross-sectional area ranging from 0.01 mm² to 50 mm², are substantially uniformly distributed over the entire area or only a certain area of the elastic layer to provide breathability. The range over which the through holes are distributed depends on the desired extent of the breathable area.

The perforation process is performed with a mechanical perforator or a laser beam, without limitation. The minimum cross-sectional area of each through hole is determined by the minimum hole size obtainable with the existing perforation techniques.

In order to form the through holes in the elastic layer, the perforation process can be performed on the elastic layer before it is bonded to the layered fabric (i.e., a so-called spacer fabric). In that case, the elastic layer is bonded to the layered fabric by first applying or spraying an adhesive onto the perforated elastic layer and then bonding the elastic layer to the layered fabric. Since there is no adhesive in the through holes, the portions of the layered fabric that correspond respectively to the through holes are not covered with adhesive, and the adhesive is kept from seeping into or clogging the tiny pores of the layered fabric. As a result, the spacer fabric remains stretchable at positions corresponding respectively to the through holes and is rendered elastic by the elastic layer once laminated therewith.

Alternatively, the perforation process can be performed on both the elastic layer and the layered fabric after they are bonded together, wherein the perforation process forms complete through holes at least in the elastic layer. In that case, the elastic layer becomes more readily stretchable because of the substantially uniformly distributed through holes and in turn makes the spacer fabric composite more readily stretchable as a whole. Besides, the pores of the layered fabric stand a relatively small chance of clogging.

Furthermore, the elastic layer is not necessarily bonded to the layered fabric by an adhesive. For instance, when the elastic layer is one or a combination of a thermoplastic elastomer film, a thermoplastic polyurethane film, a polyurethane film, an ethylene-vinyl acetate copolymer film, a thermoplastic polyolefin film, a thermoplastic polyamide elastomer film, and a hot-melt adhesive film, it can be bonded to the layered fabric by hot-press lamination. During the hot-press lamination process, however, the surface of the elastic layer will be in contact with the hot-press roller and may become uneven as a result. To prevent the formation of an uneven elastic layer, it is preferable that one side of the elastic layer is bonded to an elastic fabric by hot-press lamination before the other side of the elastic layer is bonded to the layered fabric by hot-press lamination. The elastic layer may be perforated before it is bonded to the elastic fabric by hot-press lamination. Or, the elastic layer and the elastic fabric may be perforated after they are bonded to each other. Or, the elastic layer, the elastic fabric, and the layered fabric may be perforated after the three of them of bonded together. In either case, at least the elastic layer is provided with through holes to impart elasticity to the spacer fabric composite, and the pores of the layered fabric stand a relatively small chance of clogging. The through holes also enhance breathability.

The elastic layer may be a composite film consisting of a first hot-melt adhesive film and a second hot-melt adhesive film bonded to each other, wherein: the first hot-melt adhesive film has a first melting point, the second hot-melt adhesive film has a second melting point, and the first melting point is lower than the second melting point. To bond the elastic layer to the layered fabric, the layered fabric is bonded to the first hot-melt adhesive film by hot-press lamination, with the hot-press lamination temperature higher than the first melting point and lower than the second melting point. If the temperature of the hot-press roller is higher than the second melting point, the surface of the second hot-melt adhesive film will melt and end up uneven when solidified.

Moreover, when the elastic layer is one or a combination of a thermoplastic elastomer film, a thermoplastic polyurethane film, a polyurethane film, an ethylene-vinyl acetate copolymer film, a thermoplastic polyolefin film, a thermoplastic polyamide elastomer film, and a hot-melt adhesive film, it may be bonded to the layered fabric while in a molten state and in the form of a mesh during its manufacture, and the spacer fabric composite will form once the elastic layer solidifies. The resulting composite film has through holes and is both elastic and breathable. Alternatively, the elastic layer may be bonded between the layered fabric and the elastic fabric while in a molten state and in the form of a mesh during its manufacture, and the spacer fabric composite will form once the elastic layer solidifies. The resulting composite film also has through holes and is both elastic and breathable.

When the elastic layer is one of a natural rubber, a silicone rubber, a thermoplastic rubber, a styrene-butadiene rubber, a chloroprene rubber, and a synthetic rubber, it may also be bonded to the layered fabric and the elastic fabric while in a molten and viscous state during its manufacture (typically a hot extrusion process). Once the elastic layer solidifies completely, the perforation process is performed on the layered fabric, the elastic layer, and the elastic fabric to form a spacer fabric composite featuring both elasticity and breathability.

Referring back to FIG. 4 and FIG. 5, after the layered fabric 1, the elastic layer 2, and the elastic fabric 3 are bonded together by one of the foregoing methods, and with the elastic fabric 3 being an elastic hook-and-loop fastening fabric, the bond between the layered fabric 1, the elastic layer 2, and the elastic fabric 3 is stronger than if a conventional bonding method is employed. When used as a sporting and medical brace such as a knee or elbow support, the fabric composite not only is breathable and elastic, but also is safe from separation between the elastic hook-and-loop fastening fabric and the layered fabric after repeated use.

One who has read the above description should be able to fully understand the operation, use, and effects of the present invention. The embodiments described above, however, are only some preferred embodiments of the present invention and are not intended to be restrictive of the scope of the present invention. All simple, equivalent changes and modifications made according to the appended claims and this specification should fall within the scope of the present invention.

What is claimed is:

1. A breathable and elastic spacer fabric composite, comprising:
a layered fabric comprising two knitted-fabric layers and a spacer yarns layer, the spacer yarns layer being located between and connecting the two knitted-fabric layers; and
an elastic layer bonded to the layered fabric, the elastic layer having a thickness ranging from 0.01 mm to 1.5 mm, the elastic layer being provided with a plurality of through holes each having a cross-sectional area ranging from 0.01 mm² to 50 mm².

2. The breathable and elastic spacer fabric composite of claim 1, wherein the through holes are substantially uniformly distributed over an entire area or a partial area of the elastic layer.

3. The breathable and elastic spacer fabric composite of claim 1, wherein the elastic layer is in form of a mesh.

4. The breathable and elastic spacer fabric composite of claim 1, wherein the layered fabric is provided with a plurality of through holes each having a cross-sectional area ranging from 0.01 mm² to 50 mm².

5. The breathable and elastic spacer fabric composite of claim 4, wherein the through holes of the layered fabric are substantially uniformly distributed over an entire area or a partial area of the layered fabric.

6. The breathable and elastic spacer fabric composite of claim 1, wherein the elastic layer is added with one or a combination of a far-infrared material, a negative-ion material, an anti-bacterial material, a tourmaline material, a bamboo charcoal powder material, a cool sensation-producing material, a heat-generating material, a titanium material, and a geranium material.

7. The breathable and elastic spacer fabric composite of claim 1, wherein the elastic layer is one or a combination of a thermoplastic elastomer film, a thermoplastic polyurethane film, a polyurethane film, an ethylene-vinyl acetate copolymer film, a thermoplastic polyolefin film, a thermoplastic polyamide elastomer film, and a hot-melt adhesive film.

8. The breathable and elastic spacer fabric composite of claim 1, wherein the elastic layer is made of one of a natural rubber, a silicone rubber, a thermoplastic rubber, a styrene-butadiene rubber, a chloroprene rubber, and a synthetic rubber.

9. The breathable and elastic spacer fabric composite of claim 1, further comprising an elastic fabric bonded to the elastic layer, wherein the elastic fabric is one of a knitted elastic fabric, an elastic hook-and-loop fastening fabric, a velcro plush, a far-infrared elastic fabric, a negative-ion elastic fabric, an anti-bacterial elastic fabric, a tourmaline elastic fabric, a bamboo charcoal-based elastic fabric, a geranium elastic fabric, a moisture-absorbing and perspiration-dissipating elastic fabric, a cool sensation-producing elastic fabric, a heat-generating elastic fabric, a titanium elastic fabric, a synthetic-fiber elastic fabric, and a natural-fiber elastic fabric.

10. The breathable and elastic spacer fabric composite of claim 9, wherein the elastic fabric is provided with a plurality of through holes distributed substantially uniformly over an entire area or a partial area of the elastic fabric.

11. A method for making a breathable and elastic spacer fabric composite, comprising the steps of:
bonding an elastic layer to a layered fabric, wherein the layered fabric comprises two knitted-fabric layers and a spacer yarns layer, the spacer yarns layer is located between and connects the two knitted-fabric layers, and the elastic layer has a thickness ranging from 0.01 mm to 1.5 mm; and
performing a perforation process to provide at least the elastic layer with a plurality of through holes, wherein each said through hole has a cross-sectional area ranging from 0.01 mm² to 50 mm².

12. The method of claim 11, wherein the through holes are substantially uniformly distributed over an entire area or a partial area of the elastic layer.

13. The method of claim 11, wherein the perforation process is performed with a mechanical perforator or a laser beam.

14. The method of claim 11, wherein the elastic layer is one or a combination of a thermoplastic elastomer film, a thermoplastic polyurethane film, a polyurethane film, an ethylene-vinyl acetate copolymer film, a thermoplastic polyolefin film, a thermoplastic polyamide elastomer film, and a hot-melt adhesive film, and the method further comprises the step of incorporating an elastic fabric, the elastic fabric being bonded to one side of the elastic layer by hot-press lamination before the layered fabric is bonded to an opposite side of the elastic layer by hot-press lamination.

15. The method of claim 11, wherein the elastic layer is one or a combination of a thermoplastic elastomer film, a thermoplastic polyurethane film, a polyurethane film, an ethylene-vinyl acetate copolymer film, a thermoplastic polyolefin film, a thermoplastic polyamide elastomer film, and a hot-melt adhesive film; and the elastic layer is bonded to the layered fabric while in a molten state and in form of a mesh during manufacture of the elastic layer and, once solidified, forms a meshed elastic layer bonded with the layered fabric and defining the through holes.

16. The method of claim 11, wherein the elastic layer is one or a combination of a thermoplastic elastomer film, a thermoplastic polyurethane film, a polyurethane film, an ethylene-vinyl acetate copolymer film, a thermoplastic polyolefin film, a thermoplastic polyamide elastomer film, and a hot-melt adhesive film; the method further comprises the step of incorporating an elastic fabric; and the elastic layer is bonded between the layered fabric and the elastic fabric while in a molten state and in form of a mesh during manufacture of the elastic layer and, once solidified, forms a meshed elastic layer bonded with the layered fabric and the elastic fabric and defining the through holes.

17. The method of claim 11, wherein the elastic layer comprises a first hot-melt adhesive film and a second hot-melt adhesive film bonded with each other, the first hot-melt adhesive film has a first melting point, the second hot-melt adhesive film has a second melting point, the first melting point is lower than the second melting point, and the layered fabric is bonded to the first hot-melt adhesive film by hot-press lamination, with a hot-press lamination temperature higher than the first melting point and lower than the second melting point.

18. The method of claim 11, wherein the elastic layer is sprayed with an adhesive before being bonded to the layered fabric.

19. The method of claim 11, wherein the elastic layer is made of one of a natural rubber, a silicone rubber, a thermoplastic rubber, a styrene-butadiene rubber, a chloroprene rubber, and a synthetic rubber by a hot extrusion process; the method further comprises the step of incorporating an elastic fabric; the elastic layer is bonded to the layered fabric and the elastic fabric during the hot extrusion process while the elastic layer is not yet completely solidified and is viscous; and the perforation process is performed on the layered fabric, the elastic layer, and the elastic fabric after the elastic layer solidifies completely.
